(19) United States
(12) Patent Application Publication
(10) Pub. No.: US 2009/0045344 A1
(43) Pub. Date: Feb. 19, 2009

(54) Radiation converter, detector module, methods for the production thereof, and a radiation detection device

(76) Inventors: Bjorn-Oliver Eversmann, Palzing (Zolling) (DE); Bjorn Heismann, Erlangen (DE); Stefan Wirth, Erlangen (DE)

Correspondence Address: HARNESS, DICKEY & PIERCE, P.L.C., P.O.BOX 8910, RESTON, VA, 20195, US

(21) Appl. No.: 12/219,612

(22) Filed: Jul. 24, 2008

(30) Foreign Application Priority Data
Aug. 13, 2007 (DE) 10 2007 038 189.3

(51) Int. Cl. G01T 1/20

(52) U.S. Cl. 250/361 R

(57) ABSTRACT

A radiation converter is disclosed. In order to improve the detection of x-ray radiation or gamma radiation, at least one embodiment of the invention provides that, in the case of the radiation converter with a plurality of converter elements for converting x-ray radiation or gamma radiation to light, in each case one light outlet window is formed on a light outlet side of the converter elements such that, on the light outlet side, the converter elements are covered in part by reflector material in a layered fashion.

### PRIORITY STATEMENT

The present application hereby claims priority under 35 U.S.C. §119 on German patent application number DE 10 2007 038 189.3 filed Aug. 13, 2007, the entire contents of which is hereby incorporated herein by reference.

### FIELD

Embodiments of the invention generally relate to a radiation converter, a detector module including the radiation converter, methods for the production thereof and a radiation detection device including the detector module.

### BACKGROUND

A detector module with a radiation converter for converting x-ray radiation to light is disclosed in U.S. Pat. No. 6,898,265 B1, for example. The known radiation converter has a multiplicity of scintillator elements arranged in the form of a matrix. A coating is provided which is composed of a reflector material on five side surfaces of the scintillator elements. Photodiodes for converting the light created in the scintillator elements to electrical signals are applied to a sixth side surface of the scintillator elements located on the light outlet side.

A disadvantage of the known detector module is that, as a result of the noise produced by the photodiodes, no satisfactory qualitative conversion of the x-ray radiation to electrical signals can be achieved, particularly in the case of low-intensity light.

### SUMMARY

In at least one embodiment of the invention, at least one of the disadvantages according to the prior art is improved upon or overcome. In particular, a radiation converter is intended to be specified, on the basis of which particularly effective conversion of x-ray radiation or gamma radiation to electrical signals is possible. Furthermore, in at least one embodiment a detector module is intended to be specified, by way of which x-ray radiation or gamma radiation can be particularly effectively converted to electrical signals. A further aim of at least one embodiment is to specify methods for the production of the radiation converter or the detector module, and also a radiation detection device including the detector module.

A first aspect of at least one embodiment of the invention relates to a radiation converter including a plurality of converter elements arranged next to one another for converting x-ray radiation or gamma radiation to light. The converter elements are strung together in at least one row. Within the scope of at least one embodiment of the invention, it is also possible for the converter elements to be arranged in rows and columns—that is to say in the form of a matrix.

To avoid light-optical crosstalk, a reflector layer is provided at least between mutually opposite side surfaces of adjacent converter elements. Such reflector layers are also, inter alia, known as septa. The radiation converter has a radiation inlet side and a light outlet side opposite it.

According to at least one embodiment of the invention, in each case one light outlet window is provided for each converter element on the light outlet side such that, on the light outlet side, the converter elements are in each case covered in part by reflector material in a layered fashion.

When using the radiation converter as intended, x-ray or gamma radiation is incident on the converter element from the radiation inlet side and is converted to light therein. The light is output from the converter element via the light outlet window which is smaller than a light-outlet-side base area of the converter element and is, by way of example, detected by photodiodes and the like.

The inventors have recognized, in at least one embodiment, that particularly effective conversion of the x-ray or gamma radiation to electrical signals is possible by way of the reduced light outlet window: firstly, the intensity of a light pulse effected by an x-ray or gamma absorption event can be increased by the reduced-area light outlet window, that is to say a form of focusing of the light can be achieved. Secondly, light converter elements, for example photodiodes, with a smaller converter area can be used. In particular, by using smaller converter areas, the ratio of the signal amplitude of the electrical signals to the electronic noise of the light converter elements and/or downstream electronic circuits can be improved. When using photodiodes as light converter elements, smaller electrical capacitances result from the reduction of the converter area, which leads to an effective improvement in the noise properties. This allows qualitatively particularly exact detection of the light and hence the x-ray or gamma radiation.

In addition, the reflector material on the light outlet window side can also be applied to the reflector layers provided between the converter elements. This is advantageous for applying the reflector material on the light outlet window side and, accompanying this, it is advantageous for the production of the radiation converter.

An increase in the proportion of the light that can be effectively output via the light outlet window can be achieved by ensuring that the converter elements, with the exception of the light outlet windows, are completely covered by reflector material. In this case, and in the case of cuboid converter elements, five side surfaces of the converter elements are completely covered by reflector material, and the light outlet side is covered in part by reflector material. Generalized for an arbitrary geometry of the converter elements, this means that a covering surface located on the radiation inlet side and an adjoining shell of the converter elements are completely covered by reflector material, and that a surface or base area located on the light outlet side is covered only in part by reflector material. To clarify the term shell, it should be noted that the overall surface of the converter element is composed of a covering surface, shell, and base area on the radiation outlet side.

For the purpose of at least one embodiment of the invention, the reflector material provided on the covering surface, base area, and shell can, in each case, have similar—but also different—compositions and properties. In this case it is important that the reflector material in each case has at least one function for back-scattering the light into the converter element. For example, a difference in the composition can be seen in the absorptivity of x-ray or gamma radiation. From this point of view, it is particularly advantageous if the reflector material provided on the light outlet side substantially absorbs the part of the x-ray or gamma radiation that is not absorbed in the converter elements and in the additional reflector layers. In this case, “substantially absorbs” means that the x-ray or gamma radiation in any case is absorbed such that electronic signal processing elements provided on the reflector material on the light outlet side for processing or further processing of the electrical signals of the light converter elements, such as analog-to-digital converters and the like, are shielded at least in such a way that their function is not significantly impaired. That is to say that the impairment by x-ray or gamma radiation can be ignored within the scope of the desired accuracy.

The light outlet windows can substantially have any relative position with regard to the respective converter element surfaces on the light outlet side, that is to say base areas. However, for the purposes of simple production and/or isotropic conversion properties of the converter elements it is advantageous if the light outlet windows are in each case arranged centrally or at the edge with regard to the respective base areas on the light outlet side.

According to a second aspect of at least one embodiment of the present invention, a detector module is provided which comprises the radiation converter according to the invention or a refinement thereof. In each case, the detector module has at least one light converter element, for example a photodiode, at the light outlet windows for converting the light to electrical signals.

It should be noted that, although in each case only the part of the light escaping through the light outlet window can be detected, due to the lack of precise knowledge of losses in the converter element and in the light converter elements, the respective electrical signal represents a measure for the light produced in the converter element by means of absorption of the x-ray and gamma radiation, so that the expression “for converting the light to electrical signals” is justified for all intents and purposes. Preferably, the light converter elements fill in the light outlet windows with regard to their converter surface, that is to say the sizes of the light outlet windows and the light converter elements are matched to one another.

With regard to advantages and advantageous effects of the detector module, reference is made in this respect to the advantages and advantageous effects of the radiation converter and its refinements.

To improve the conversion efficiency, an optical coupling medium can be provided between the converter elements and the light converter elements. The coupling medium allows an effective improvement of the optical transfer and thus of the conversion efficiency. Particularly advantageous optical transfer can be achieved by matching the coupling medium to the optical properties of the converter elements and light converter elements, for example. One candidate for the optical property is the average optical refractive index, which, for modern converter element materials and light converter elements according to the prior art, can lie in the range between 1.1 and 2.5, preferably in the range between 1.3 and 2.2. Any materials compatible with the converter elements and the light converter elements are suitable, for the coupling medium. Advantageously, the coupling medium includes an adhesive, thus allowing the light converter elements to be fixed easily to the light outlet windows at the same time.

Furthermore, the detector module can include signal processing elements, such as analog-to-digital converters and the like, for processing the electrical signals. The signal processing elements can be applied on the reflector material provided on the light outlet side. In so far as the function of the signal processing elements is sensitive to x-ray or gamma radiation, it is particularly advantageous if the light converter elements are shielded from x-ray or gamma radiation. This can be carried out, for example, by means of a specialty provided shield. In place of the shield, or in addition to it, the reflector material provided on the light outlet side can have x-ray absorbing properties.

According to a third aspect of an embodiment of the invention, a radiation detection device, which in particular can be an x-ray computed tomography scanner, is provided which includes the detector module according to at least one embodiment of the invention or a refinement thereof. Advantages and advantageous effects of the radiation detection device result directly from the advantages and advantageous effects of the radiation converter and detector module, including their refinements.

According to a fourth aspect of an embodiment of the invention, a method for producing the radiation converter according to the invention is provided. The method comprises the following steps:
producing a bundle of a plurality of converter elements, arranged next to one another at least in rows, for converting the x-ray radiation or gamma radiation to light, a reflector layer being provided in each case, at least between mutually opposite side surfaces of adjacent converter elements, for avoiding optical crosstalk, with the radiation converter having a light outlet side lying opposite a radiation inlet side, and
applying a reflector material to the light outlet side such that at least the converter elements are in each case covered in part by reflector material in a layered fashion on the light outlet side so that a light outlet window is thus formed for each converter element.

The method allows the production of the radiation converter according to at least one embodiment of the invention in simple steps, so that its advantages and advantageous effects can be achieved in a simple manner and without significant additional effort compared to conventional production methods.

According to refinements of the radiation converter explained in more detail above, in the case of at least one embodiment of the method, it is possible for
the reflector layers on the light outlet side to be covered, at least in part, by reflector material;
the converter elements on the radiation inlet side to be covered by reflector material;
the converter elements to be completely covered by reflector material, with the exception of the light outlet windows;
the reflector material applied on the light outlet side to be designed such that a part of the x-ray radiation or gamma radiation that is not absorbed in the converter elements or the reflector layers is substantially absorbed;
the reflector material on the light outlet side to be applied such that the light outlet windows are in each case formed centrally or at the edge with regard to respective base areas of the converter elements on the light outlet side.

By way of the abovementioned additional steps quoted in the form of a list, it is possible to produce refinements of the radiation converter in a simple and effective manner.

A fifth aspect of at least one embodiment of the invention provides a method for producing the detector module according to at least one embodiment of the invention or a refinement thereof. The method according to the fifth aspect comprises the steps of the method according to the fourth aspect, and the additional step of:
applying in each case at least one light converter element for converting the light to electrical signals at the light outlet windows.

In the case of the method according to the fifth aspect, an optical coupling medium can be provided in a further step between the converter elements and the light converter elements to improve optical transfer of the light from the converter elements to the light converter elements.

The coupling medium can be selected such that its average refractive index lies between 1.1 and 2.5, preferably between 1.3 and 2.2, with the coupling medium in particular being able to be produced on the basis of an adhesive.

The reflector material on the light outlet side can be produced by mixing a carrier substance and an x-ray absorbing substance.

In a further step, it is possible to apply signal processing elements for processing the electrical signals to the reflector material provided on the light outlet side.

By way of the method according to the fifth aspect or a refinement thereof, it is possible to produce, in a simple and cost-effective manner, a detector module having the above-described advantageous properties.

### BRIEF DESCRIPTION OF THE DRAWINGS

In the following, example embodiments will be explained in more detail with reference to figures, in which

FIG. 1 shows an x-ray computed tomography scanner;

FIG. 2 shows a plan view of a detector module according to an embodiment of the invention;

FIG. 3 shows a perspective, partly cut away view of a section of the radiation converter according to an embodiment of the invention;

FIG. 4 shows a cross section through the detector module including the radiation converter;

FIG. 5 shows a bottom view of the radiation converter shown in FIG. 3;

FIGS. 6 to 9 show bottom views of further refinements of the radiation converter shown in FIG. 3;

FIG. 10 schematically shows a flowchart of a method for producing the detector module shown in FIG. 4; and

FIG. 11 shows a cross section through a radiation converter according to the prior art.

Except where stated to the contrary, the rest of the description, in particular the figures, is based on identical or functionally identical elements being denoted in the figures by the same reference symbols throughout. The illustrations in the figures are not to scale and the scale can vary between figures. The x-ray computed tomography scanner, the detector module, and the radiation converter are discussed in the following only to the extent that is necessary for understanding the invention.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein; the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

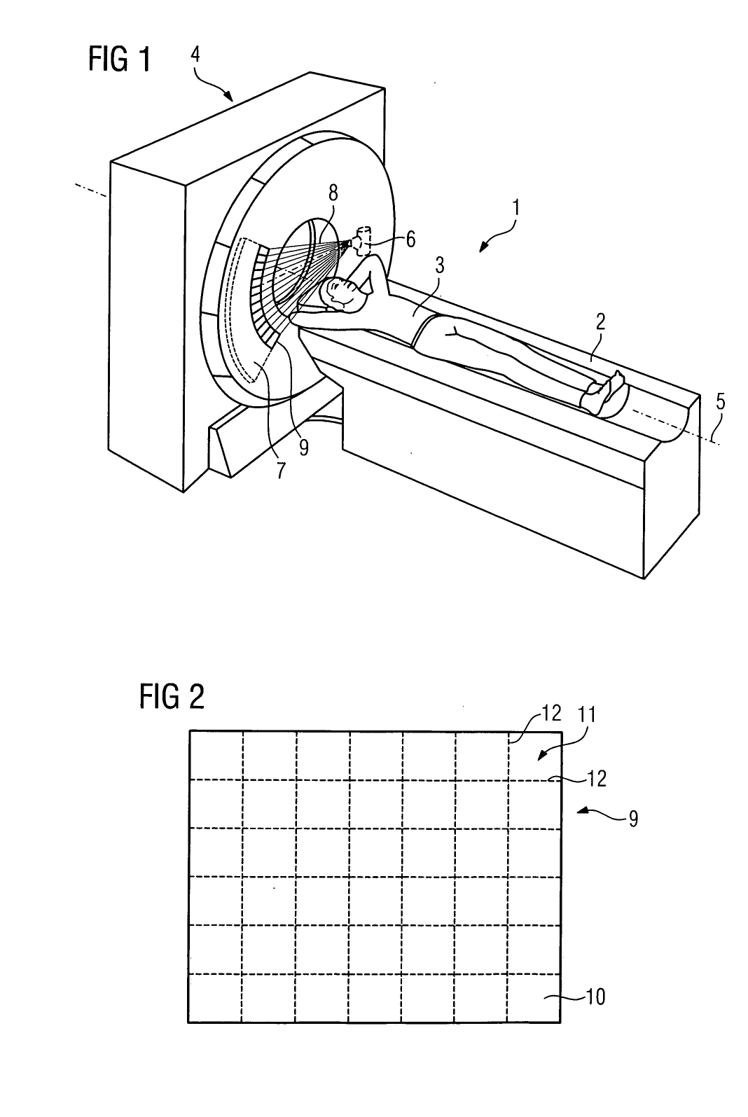

FIG. 1 shows an x-ray computed tomography scanner 1 having a patient support table 2 with a patient 3 to be examined located thereon, and a gantry 4, the housing of which holds a tube detector system mounted rotatably abou a system axis 5. The tube detector system includes an x-ray tube 6 and an x-ray detector 7 provided opposite it. During operation of the x-ray computed tomography scanner 1, x-ray radiation 8 is emitted by the x-ray tube 6 in the direction of the x-ray detector 7 and, can be detected by the x-ray detector 7.

The x-ray detector 7 has a plurality of detector modules 9, arranged at least in one row with regard to the system axis. The x-ray detector 7 can also have a plurality of rows, arranged next to one another, in the direction of the system axis 5.

Each detector module 9 has a multiplicity of x-ray converter elements 10, arranged in the form of a matrix. A plan view of an x-ray radiation inlet side 11 of the detector module 9 is illustrated in FIG. 2, wherein the number of the x-ray converter elements 10 is exemplary, should not be seen as a limitation and can vary from the number illustrated. In the x-ray converter element 10, the x-ray radiation 8 is—at least for the most part—absorbed and converted to light, which is denoted by reference symbol 19 in FIG. 4. The x-ray radiation 8 is thus converted to light 19 in a first conversion step.

To avoid optical crosstalk, septa 12 are provided between the individual x-ray converter elements 10, and are produced from a back-scattering material substantially impermeable to light.

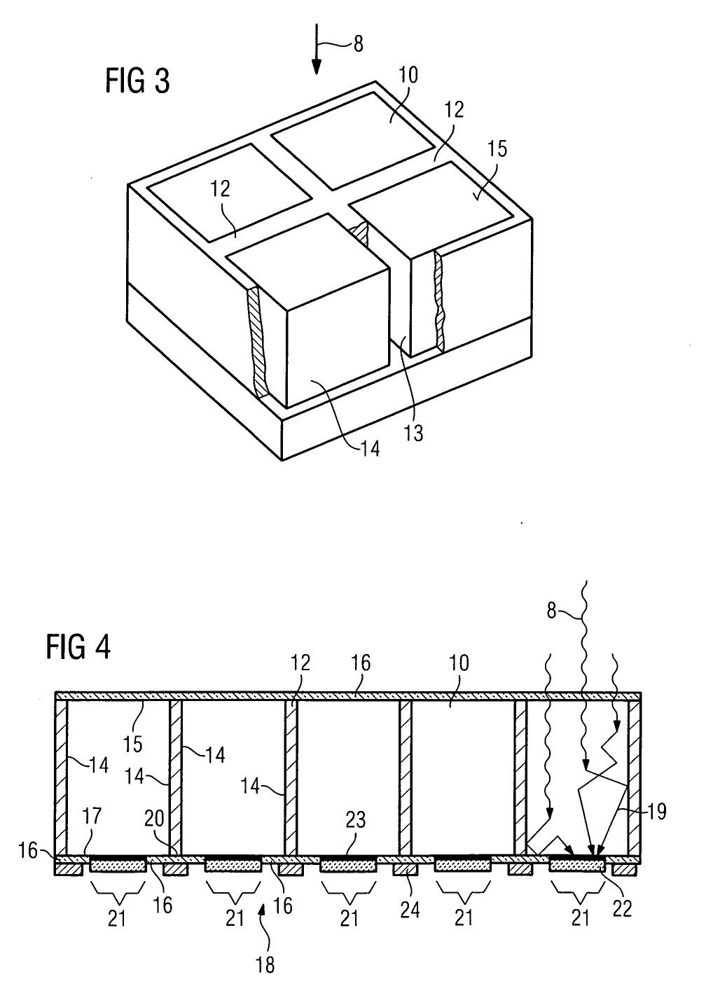

The septa 12 are arranged between mutually opposite side surfaces 13 of the x-ray converter elements 10 and on their exposed edge-side surfaces 14 as shown in FIG. 3, which illustrates a plurality of x-ray converter elements 10 in a perspective view. Furthermore, a covering surface 15 of the x-ray converter elements 10 on the x-ray radiation inlet side is covered by a reflector material, denoted by 16 in FIG. 4. In this respect, the light 19 is back-scattered at the interface of the x-ray converter elements 10. This may result in there being a high probability of the light 19 migrating to a base area 17 on a light outlet side 18 of the x-ray converter element 10 located opposite to the covering surface 15.

The septa 12 and the reflector material 16 that is provided thus make it possible for the light 19, once created, to escape from the x-ray converter element 10 at the corresponding side surfaces 13, or edge-side surfaces 14, or the covering surface 15. This can achieve particularly accurate detection of the x-ray radiation 8. Aside from this, optical crosstalk between adjacent x-ray converter elements 10 can be avoided by means of the septa 12; this can improve the point spread function or the transfer function of the x-ray detector 7.

As can be seen in more detail in the cross-sectional illustration in FIG. 4, the respective base areas 17 of the x-ray converter elements 10 are in part covered by reflector material 16 in a layered fashion, with septa base areas 20 of the septa 12 on the light outlet window side also being covered by the reflector material 16. As a result of this, a light outlet window 21 is defined on the base area 17 on the light outlet side. The light 19 is back-scattered into the x-ray converter element 10 in particular by the previously mentioned reflector material 16 provided on the light outlet side. The light 19 can leave the x-ray converter element 10 only through the light outlet window 21.

Photodiodes 22 are provided to detect the light 19 escaping through the light outlet windows 21, and to generate electrical signals. The light 19 is thus converted to electrical signals in a second conversion step. An attenuation image of at least a section of the body of the patient 3 can be calculated on the basis of the electrical signals.

The photodiodes 22 are fitted into the respective light outlet windows 21, or, to put it another way, the sizes of the light outlet windows 21 and the photodiodes 22 are matched to one another. The photodiodes 22 are fit to the x-ray converter elements 10 on the light outlet side by means of an adhesive 23 which is used as a coupling medium to improve the optical transfer of the light 19 from the x-ray converter elements 10 to the photodiodes 22.

To process or further process the electrical signals, electronic components 24 are provided on the reflector material 16 on the light outlet side in the region between the light outlet windows 21. In this case it is particularly advantageous if the reflector material 16 provided on the light outlet side is designed such that a part of the x-ray radiation 8 that is not absorbed is at least absorbed such that the components 24 are not substantially impaired, at least in their function, by the x-ray radiation 8.

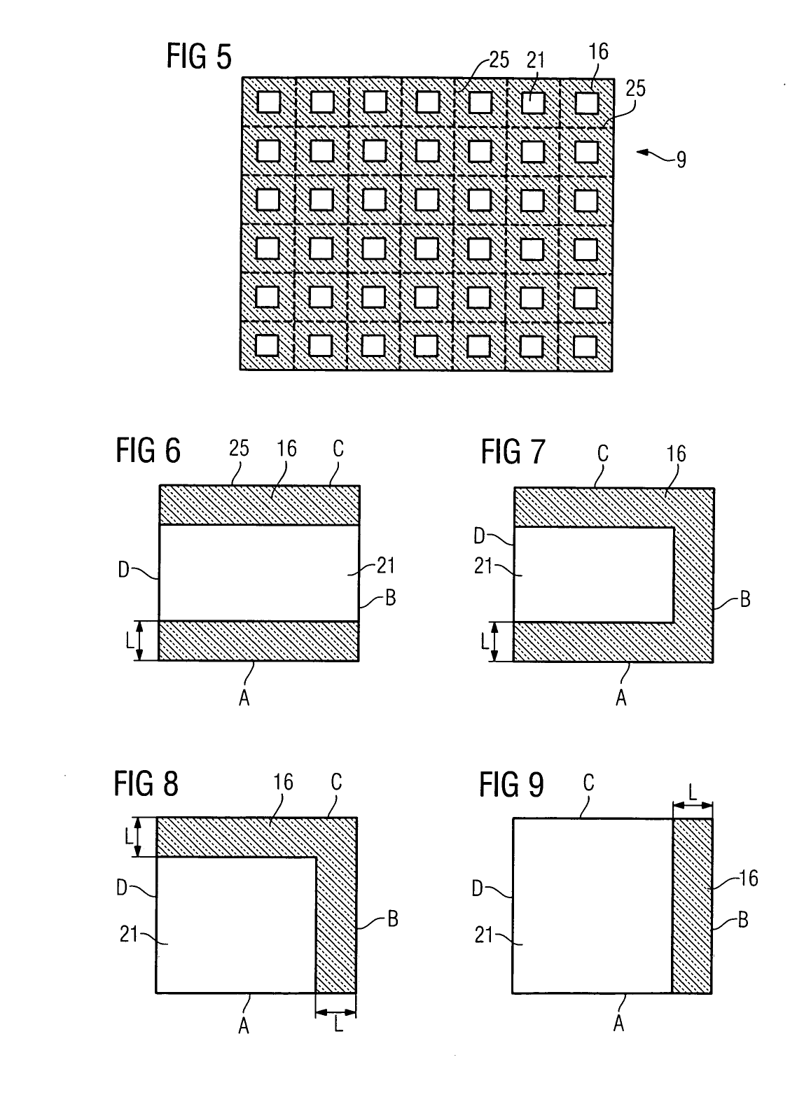

FIG. 5 illustrates a bottom view of the previously described detector module 9. The reflector material 16 provided on the light outlet side is arranged symmetrically with regard to the separation lines 25 formed by the septa 12. In the specific refinement, the light outlet windows 21 are arranged centrally with regard to the separation lines 25 or the base areas 17.

Other arrangements of the light outlet windows 21 relative to the base areas 17, in particular taking the respective geometric shapes of the respectively used photodiodes 22 into account, are conceivable. Accordingly, FIGS. 6 to 9 show examples of other relative arrangements of the light outlet windows 21 relative to the respective base areas 17 or separation lines 25. For the sake of simplifying the description, four separation lines 25 which surround the base area 17 are referred to, in the counterclockwise direction, as A, B, C, and D.

In FIG. 6, the base area 17 is covered by the reflector material 16 at the separation lines A and C. The light outlet window 21 in this case extends in a central area of the base area 17 from the separation line B to the separation line D. FIG. 7 shows a refinement in which the base area 17 is covered by reflector material 16 along the separation lines A, B and C. The light outlet window 21 is “open on one side” on the plane of the base area 17, in the direction of the separation line D. In the case of the x-ray converter element 10 shown in FIG. 8, the reflector material 16 is provided along the separation lines B and C. Correspondingly, this results in a light outlet window 21 that is “open on two sides” on the plane of the base area 17. Finally, FIG. 9 shows a refinement in which the reflector material 17 is provided only on the separation line B.

The light outlet windows 21 in FIGS. 6 to 9 have different sizes due to the different cover of the base areas 17 by the reflector material 16. The size of the light outlet windows 21 can additionally also be adapted by a corresponding choice of width L of the cover. As mentioned, it is possible here for different geometries of the photodiodes 22 and arrangements of the x-ray converter elements 10 to be taken into account. As an aside, it should be noted that the covers shown in FIG. 5 to FIG. 9 are examples and should in no way be seen as a limitation.

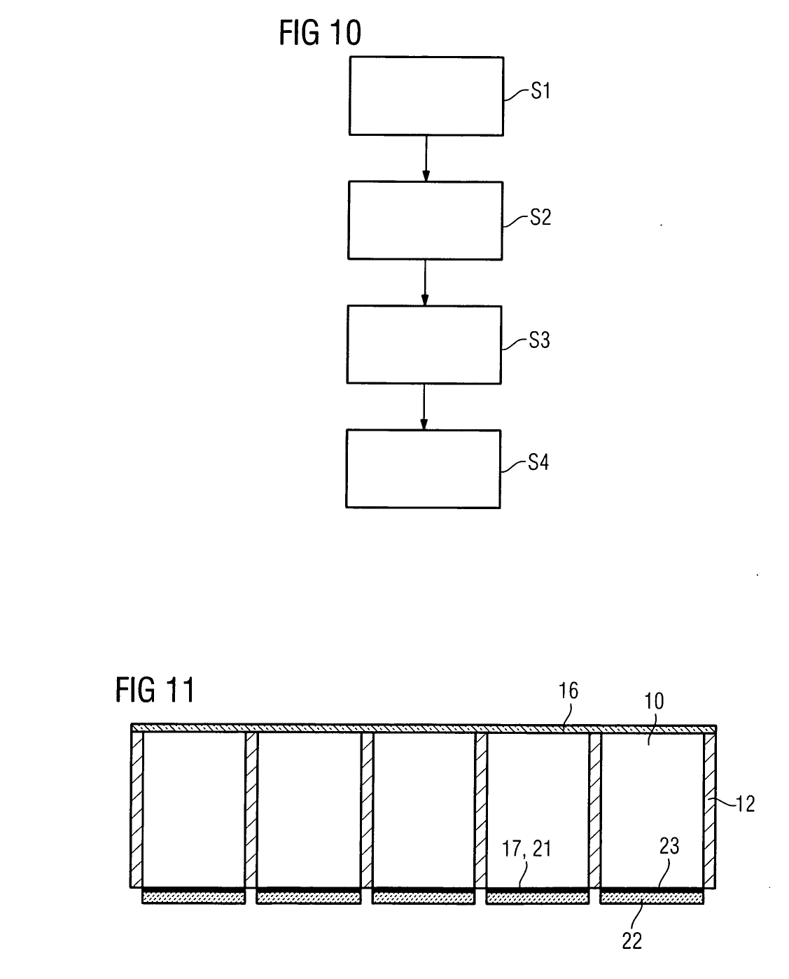

FIG. 10 schematically illustrates a flowchart for a method for producing the detector module as shown in FIG. 4.

In a first step S1, a bundle of a plurality of x-ray converter elements 10 arranged next to one another, at least in rows, is produced. In this case, septa 12 are provided in each case between mutually opposite side surfaces 13 of adjacent x-ray converter elements 10 to avoid optical crosstalk.

In a second step S2, the reflector material 16 is applied to the covering surfaces 15 and the edge-side surfaces 14 that are exposed. Furthermore, the reflector material 16 is applied on the light outlet side such that the respective light outlet window 21 is formed in this way for each x-ray converter element 10. By way of example, the reflector material 16 can be applied to produce the covers shown in FIG. 5 to FIG. 9.

The reflector material 16 applied on the light outlet window side is formed such that a part of the x-ray radiation 8 not absorbed in the x-ray converter elements 10 or septa 12 is substantially absorbed.

In a third step S3, a photodiode 22 is fit to the light outlet windows 21. An optical coupling medium, for example an adhesive 23, can be used for this purpose. The coupling medium is preferably designed to achieve optimum optical transfer of the light 8 from the respective x-ray converter element 10 to the respective photodiode 22. This can be achieved, for example, by the choice of a suitable refractive index that can have a value between 1.1 and 2.5, preferably between 1.3 and 2.2, for x-ray converter elements 10 and photodiodes 22 known from the prior art.

In a fourth step S4, components 24 are fit to the reflector material 16 provided on the light outlet side. In this case, the signal outputs of the photodiodes 22 can be electrically conductively connected to the signal inputs of the components 24.

FIG. 11 shows a cross section through a radiation converter according to the prior art. In contrast to the radiation converter according to an embodiment of the invention, no reflector material 16 is provided on the base area 17 of the x-ray converter elements 10. This means that the light outlet window 21 comprises the entire base area 17. In order to detect the light 8 escaping through the base area 17, the entire base area 17 is in each case covered by a photodiode 22.

In comparison to the radiation converter according to the prior art, the light outlet window 21 is thus smaller in the radiation converter 10 according to an embodiment of the invention. This may have, in particular, the following advantages:

A detection surface of the photodiodes 22 can be reduced in size in line with the light outlet windows 21. Photodiodes 22 with smaller detection areas have smaller capacitances, as a result of which the noise properties can be improved. The noise component, in particular the electronic noise in the electrical signals, is decreased due to the higher intensity of the light from the reduced light outlet window 21. These effects contribute to the fact that the x-ray radiation 8 can be detected more precisely, and qualitatively high-grade attenuation images can be generated.

In addition, the area on the light outlet side not taken up by the photodiodes 22 can be used to fit the electronic components 24. As a result, a particularly compact design can be achieved.

Further, elements and/or features of different example embodiments may be combined with each other and/or substituted for each other within the scope of this disclosure and appended claims.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A radiation converter, comprising:
a plurality of converter elements arranged next to one another, at least in rows, for converting x-ray radiation or gamma radiation to light;
a plurality of reflector layers each provided, for a respective one of the plurality of converter elements, at least between mutually opposite side surfaces of adjacent converter elements, for avoiding optical crosstalk, the radiation converter including a light outlet side opposite a radiation inlet side, wherein one light outlet window is provided for each converter element on the light outlet side such that, on the light outlet side, the converter elements are each covered, at least in part, by reflector material in a layered fashion.

2. The radiation converter as claimed in claim 1, wherein the reflector layers are covered on the light outlet side by reflector material.

3. The radiation converter as claimed in claim 1, wherein the converter elements are covered on the radiation inlet side by reflector material.

4. The radiation converter as claimed in claim 1, wherein the converter elements are completely covered by reflector material, with the exception of the light outlet windows.

5. The radiation converter as claimed in claim 1, wherein the reflector material provided on the light outlet side is designed such that a part of the x-ray radiation or gamma radiation that is not absorbed is substantially absorbed.

6. The radiation converter as claimed in claim 1, wherein the light outlet windows are each arranged centrally or at the edge with regard to respective x-ray converter element surfaces on the light outlet side.

7. A detector module, comprising:
a radiation converter as claimed in claim 1, wherein at least one light converter element is provided on the light outlet windows for converting the light to electrical signals.

8. The detector module as claimed in claim 7, wherein an optical coupling medium is provided between the converter elements and the light converter elements to improve optical transfer of the light from the converter elements to the light converter elements.

9. The detector module as claimed in claim 8, wherein the coupling medium has an average refractive index between 1.1 and 2.5.

10. The detector module as claimed in claim 8, wherein the coupling medium comprises an adhesive.

11. The detector module as claimed in claim 7, wherein signal processing elements for processing the electrical signals are provided on the reflector material provided on the light outlet side.

12. A radiation detection device, comprising:
an x-ray detector including a plurality of detector modules as claimed in claim 7.

13. A method for producing a radiation converter, comprising:
producing a bundle of a plurality of converter elements, arranged next to one another at least in rows, for converting the x-ray radiation or gamma radiation to light, and providing a plurality of reflector layers, each at least between mutually opposite side surfaces of adjacent respective converter elements, for avoiding optical crosstalk, with the radiation converter having a light outlet side lying opposite a radiation inlet side; and
applying a reflector material to the light outlet side such that at least the converter elements are each covered at least in part by reflector material in a layered fashion on the light outlet side so that a light outlet window is thus formed for each converter element.

14. The method as claimed in claim 13, wherein the reflector layers are covered on the light outlet side by reflector material.

15. The method as claimed in claim 13, wherein the converter elements are covered on the radiation inlet side by reflector material.

16. The method as claimed in claim 13, wherein the converter elements are completely covered by reflector material, with the exception of the light outlet windows.

17. The method as claimed in claim 13, wherein the reflector material applied to the light outlet side is designed such that a part of the x-ray radiation or gamma radiation that is not absorbed is substantially absorbed.

18. The method as claimed in claim 13, wherein the reflector material is applied on the light outlet side such that the light outlet windows are each designed centrally or at the edge with regard to respective base areas of the converter elements on the light outlet side.

19. A method for producing a detector module, comprising the method as claimed in claim 13 and further comprising:
applying at least one light converter element for converting the light to electrical signals at each respective light outlet window.

20. The method as claimed in claim 19, wherein an optical coupling medium is provided between the respective converter elements and the light converter elements to improve optical transfer of the light from the converter elements to the light converter elements.

21. The method as claimed in claim 20, wherein the coupling medium is produced such that its average refractive index lies between 1.1 and 2.5.

22. The method as claimed in claim 20, wherein the coupling medium is produced on the basis of an adhesive.

23. The method as claimed in claim 20, wherein the reflector material on the light outlet side is produced by mixing a carrier substance and an x-ray absorbing substance.

24. The method as claimed in claim 19, further comprising:
applying signal processing elements designed for processing the electrical signals to the reflector material provided on the light outlet side.

25. The radiation converter as claimed in claim 2, wherein the converter elements are covered on the radiation inlet side by reflector material.

26. A detector module, comprising:
a radiation converter as claimed in claim 2, wherein at least one light converter element is provided on the light outlet windows for converting the light to electrical signals.

27. The detector module as claimed in claim 9, wherein the coupling medium has an average refractive index between 1.3 and 2.2.

28. The radiation detection device as claimed in claim 12, wherein the radiation detection device is an x-ray computed tomography scanner.

29. The method as claimed in claim 14, wherein the converter elements are covered on the radiation inlet side by reflector material.

30. The method as claimed in claim 21, wherein the coupling medium has an average refractive index between 1.3 and 2.2.
